(19) United States
(12) Patent Application Publication
(10) Pub. No.: US 2018/0169541 A1
(43) Pub. Date: Jun. 21, 2018

(54) SOLAR DESALINATION DEVICE AND METHOD

(71) Applicant: Matthew James Anderson, Alexandria, VA (US)

(72) Inventor: Matthew James Anderson, Alexandria, VA (US)

(21) Appl. No.: 15/383,492

(22) Filed: Dec. 19, 2016

(51) Int. Cl. B01D 1/00; C02F 1/14; B01D 1/04; B01D 1/06; F01K 11/02

(52) U.S. Cl. CPC B01D 1/0035; C02F 1/14; C02F 2103/08; B01D 1/06; F01K 11/02; B01D 1/04

(57) ABSTRACT

A solar desalination system that heats sea water in pressurized columns and controls the release of the steam so that energy can be generated. The heating columns normally operate in parallel and are heated by cylindrical mirrors which concentrate sunlight on each heating column. The heated sea water is turned to steam and ejected out of the heating column to a turbine for power generation. The resulting water is then fed to a water tank.

### FIELD OF THE INVENTION

The invention is related to removing salt from ocean water using only solar energy for a positive energy output and production of potable water.

### DESCRIPTION OF THE BACKGROUND ART

Solar desalination has been used since ancient times with variations on a simple arrangement that includes an evaporation column with a condenser above the column that diverts the condensed water into a separate reservoir. This can be done with a simple sloping surface on the cap that collects and drains the water droplets. However, in normal high temperature situations, especially when under solar radiation, the cap or the entire device becomes too hot for condensation to naturally occur. As a result, condensation only happens once a day when the air temperature cools.

A simple desalination system disclosed in DE 3612188 to Graef provides saltwater sprayed on several evaporation columns above a mirror. The condensed water or steam is collected above by a slanted tube and guided down to a reservoir. In this configuration, the incoming seawater provides the cooling used condense the evaporated water. However, the system requires nighttime cooling or seawater cooling to work, in addition to power to pump water through sprayers and chill the cooling element. In reality, the system simply attempts to replicate the natural water cycle to provide water to plants under the evaporation canopy.

More modern systems artificially cool the condenser with refrigeration or vacuum pump the water vapor out of the top of the condenser column for remote condensing. One such system described in Chinese patent CN 101993125 to Yang, includes a separate heating panel that feeds into an evaporation column. The water vapor is pumped into another box with a condensing element at the top that is perforated to collect water and divert it to a spigot. However, again the evaporation column is separate from the portion of the system heating the water and requires an artificially cooled condensing element.

Finally, a more streamlined and serial system disclosed in Chinese patent CN 2452996 to Ming et al. provides a number of sloped tubes through which saltwater flows downhill after being pumped uphill. The water which evaporates on the journey down the tube is pumped out with a fan to a steam condenser and a water storage tank. However, the tube is open at both ends and the water flows as quickly as gravity takes it down back to the ocean. As a result, the tube remains rather cool and evaporation is insignificant unless the volume of water is low.

These systems require energy for cooling, compression, and fans to pump the water vapor through the system. Additionally, the devices of Yang and Graef are also very susceptible to clogging with the salt precipitating from the saltwater. These require additional cleaning systems or manual declogging in the joints or tubes. In addition the separated heating panel of Yang is completely enclosed and vulnerable to clogging and corrosion. Indeed corrosion is one of the largest challenges to any ongoing desalination process.

Other desalination processes such as electrolysis or reverse-osmosis require significant energy use so that the most efficient systems can only produce usable water at about three dollars per gallon. In order to support the larger requirements of agriculture and household use, efficiency must get to where water is cheaper than 50 cents. The system described in this application can generate electricity along with usable water so that the only costs are the fixed costs of building the system and regular replacement of certain elements.

### SUMMARY OF THE INVENTION

The invention is directed to a solar desalination array for heating sea water into steam for the production of usable water and power generation. The heating columns normally operate in parallel and are heated by cylindrical mirrors which concentrate sunlight on each heating column. The heated sea water is either turned to steam and ejected out of the heating column or passed on to another heating column for further heating.

The cylindrical mirrors and heating columns are aligned and each provides steam at one end to a common exit pipe resulting in a high pressure flow of high temperature steam. At the exit end of each heating column, a pressure-actuated valve allows the pressure to build to a preset amount before release. The pressure-actuated valve can drive an external motor for low voltage power generation. The generated steam in the common pipe is then used to turn a turbine for generation of electrical power. By using the heat and pressure of the steam to do work in the turbine, the steam naturally condenses leaving the turbine. As a result the condensation of the water vapor produces energy rather than uses it.

Ultimately, the steam from the heating columns is condensed in a condensing column and converted to usable, potable water for irrigation and drinking. The controlling inlet and outlet valves can be switched to control the functioning of the heating tube from evaporation to high pressure steam production based on user needs and environmental conditions. The variability of the pressure flow out of the heating columns can be adjusted and managed by the outlet valves as well.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1A is a first cross-section of a desalination tube;

FIG. 1B is a second cross-section of a desalination tube;

FIG. 1C is a third cross-section of a desalination tube;

FIG. 1D is a fourth cross-section of a desalination tube;

FIG. 2A is an exemplary desalination tube in cross-section view along a different plane showing steam exits;

FIG. 2B is an exemplary desalination tube in cross-section view along a different plane showing steam exits;

FIG. 3 is a top view of two segments of an array of solar desalinators;

FIG. 4 is a side view of a segment of an array of solar desalinators;

FIG. 5 is a system diagram illustrating an overall system; and

FIG. 6 is a lateral cross-section of an embodiment having concentric glass tubes.

### DETAILED DESCRIPTION OF THE DRAWINGS

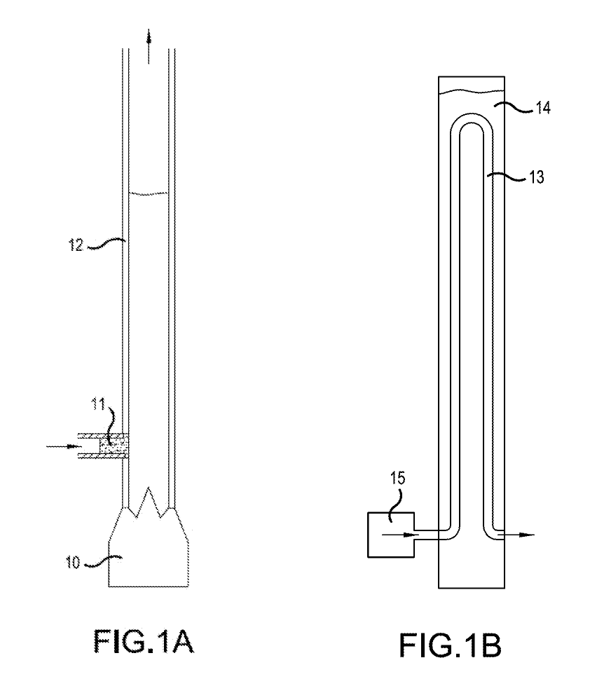

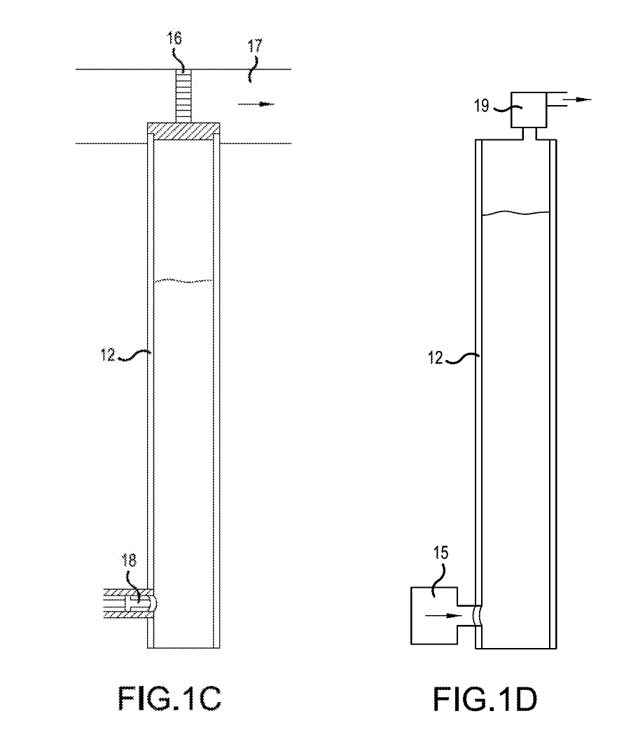

The heating columns have different configurations but substantially the same function. In each column, water is heated by concentrated sunlight such that salt water contained therein evaporates and reaches high and/or temperatures. The first configuration in FIG. 1A includes a simple main pipe 12 partially filled with sea water with a simple one way valve 11 which restricts entry of sea water into the column and is stopped when the column is in steam generation mode. The generated steam exits the column at one end and is passed to a condenser or turbine for water collection or power generation, respectively.

The configuration of FIG. 1A also includes a crystalized salt catchment 10 which allows the salt to precipitate out of the column and be removed while the system is in steam generation mode. This can be accomplished by manually or automatically sealing the catchment system 10 from the column and removing the base to empty the salt. The catchment system 10 can include a basin, an integral trap, and a watertight seal at the interface with the pipe 12 for manual separation from the desalination column. After sealing the catchment system 10, it can be removed from the pipe 12 with the seal still attached to the pipe 12 and holding the contents of the pipe 12 under pressure intact.

During steam generation mode, the column heats up and the one way stop valve 11 remains closed allowing pressure to build up. This pressure is then allowed to intermittently exit the column into an exit pipe. Preferably the exit valve 16 is controlled based on the built up pressure so that with each opening a usable pressure is released. FIG. 1C shows the exit valve 16 and the exit pipe 17 connecting to the larger system. Additionally, energy can be generated directly from the movement of the exit valve 16 much like a steam engine. Instead of the catchment system 10, the saltier water at the base of the column can be pumped out gradually.

The configuration of FIG. 1D is an automatic version of configurations in FIG. 1A and 1C such that the entrance valve 15 and the exit valve 19 are pressure activated. Preferably, the two valves 15 and 19 are synchronized so that immediately after the pressure is released at the top via valve 19, then valve 15 opens and pushes new water in to maintain a substantially constant water level in the column. This allows water to enter with the least amount of energy. For synchronized operation, the entrance valve 15 can be disposed above the water level as well to avoid the need to counteract the weight of the water. The entrance valve 15 can be a high pressure, high torque mechanical gear pump for slowly injecting sea water into the column under pressure.

In addition, the incoming water can be pre-heated by the outgoing salt water or the steam exiting the turbine in a reverse heat exchanger. The incoming cold ocean water can help condense the remaining water vapor.

Alternatively, the exit valve 19 can be restricted such that at a given operating temperature a constant pressure is allowed to exit. This maintains a constant pressure flow to downstream systems that utilize the pressurized steam further. With variable temperatures, the restriction of the exit valve can be controlled to maintain pressure. In addition, all of the configurations in FIG. 1A-1D can include the catchment system 10 shown in configuration A. Also the locations of the entrance valves 11, 18 and 15, are purely exemplary and can be placed at any location along the pipe 12. The inside of the pipe 12 can be coated with aluminides (NiAl or Ni2Al3) or FeCrAlY coatings to prevent corrosion.

The configuration in FIG. 1B contains a column 14 that absorbs the concentrated sunlight to heat a liquid inside the column 14. An entrance valve 15 pumps sea water into a flexible plastic tube 13 that is partially filled with water. The heated liquid surrounding the plastic tube 13 transfers heat to the tube and steam evaporates at a low pressure and exits the plastic tube 13 into a condenser. Alternatively, the column 14 can be an evacuated glass pipe or series of concentric glass pipes with the plastic tube disposed in the center via hooks or supports. The disclosure of U.S. Pat. No. 4,474,170 to McConnell, et al. shows a concentric glass pipe solar collector the entire disclosure of which is incorporated herein by reference.

In the embodiment where the concentric glass pipes are used, the internal reflection angle of the outer glass tube should trap infrared light into the space between the outer tube and the inner tube. Likewise, the inner pipe should trap infrared light within the water, so the internal reflection at the water/glass interface should be below the critical angle. A lateral cross section of this tube system in FIG. 6.

Alternatively, the plastic tube 13 can be completely filled with sea water and pre-heated before being passed to another one of the configurations for power generation. The desalination columns are designed to be laid out in arrays which would allow preheating with several columns 14 a straight forward design. The benefit of configuration B is that the main pipe can be used for longer without corrosion from sea water. Additionally, different liquids can be used which have higher heat conduction than water.

Preferably, configurations in FIG. 1A, 1C and 1D utilize a metal pipe 12 lined with plastic or other protectant coatings to prevent corrosion from the sea water. Metal pipes are preferred because they transfer and absorb heat well. Alternatively, thermoplastic pipes or glass pipes could be used including PPS plastics. To enhance the absorption of sunlight, the metal pipe 12 can be encased in a glass tube offset from the surface of the metal pipe 12 to trap the infrared rays (see FIG. 6). A specific ratio between the diameter of the metal pipe and the surrounding glass tube is needed such that all infrared light is internally reflected like in a fiber optic. In addition, concentric glass pipes could trap infrared light into the core and heat the water without corrosion issues.

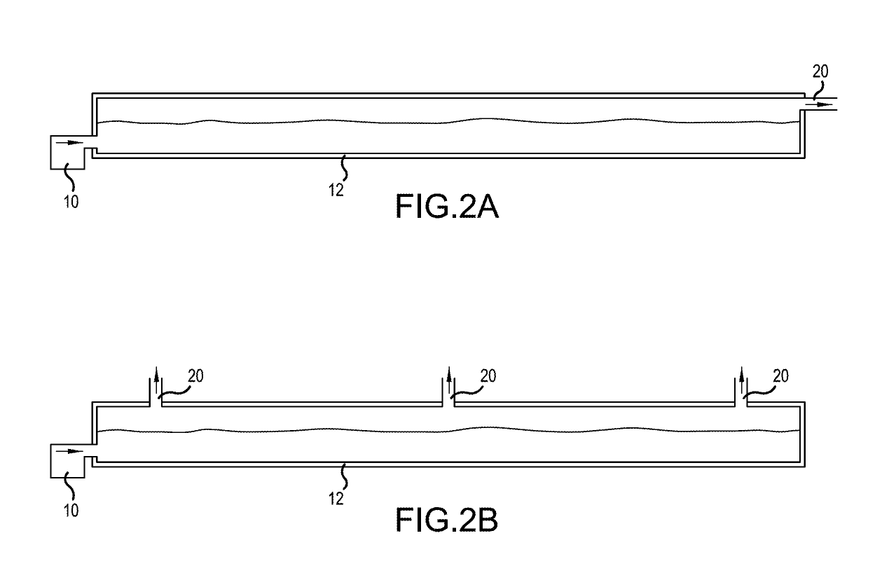

The configurations shown in FIG. 2A and FIG. 2B are simply different placements of evaporation release valves 20 and water level differences for horizontal arrays. The view in FIG. 2A parallels the structure of configuration D but because of the horizontal position more evaporation surface is provided, whereas the configurations in FIG. 1A, 1C and 1D pressure build up is optimized. Arrays of pipes 12 preferably have slopes somewhere between horizontal and vertical for maximum sun collection. The arrays are also positioned perpendicular to the travel of the sun across the sky for longer exposure times.

The configuration in FIG. 2B has several evaporation release valves above the water level and is preferably connected to other arrays in parallel for collection of the water vapor by single pipes. The number of evaporation release valves 20 in FIG. 2B makes this configuration less suited to pressure build up and power generation. Preferably if the pipe 12 is sloped slightly, all the release valves should be above the water line to prevent salt water from contaminating the pure water vapor supply. The T-head connections of most of the release valves used in configurations of FIG. 1A, 1C, 1D, FIG. 2A and FIG. 2B, and shown in configurations of FIG. 1C and 1D also prevent splash salts from traveling too far down the exit pipe 17.

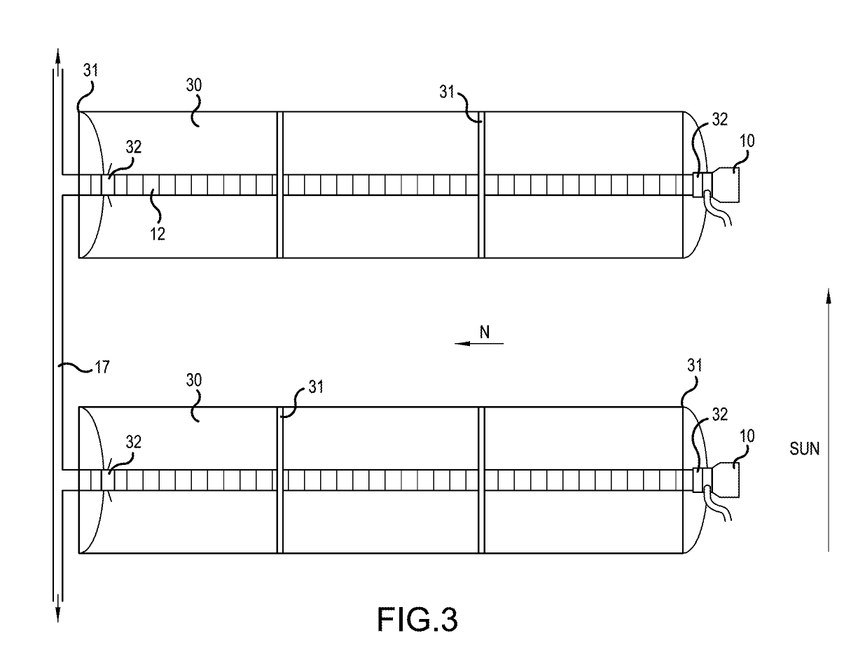

The array segment of FIG. 3 shows the previously illustrated pipes in place mounted to cylindrical mirrors 30. The pipes are preferably slip-mounted to the mirrors 30 via mounts 32 so that the mirrors can rotate to track the sun without requiring movement of the pipes 12 which are fixed to the main exit pipe 17. Each pipe 12 is provided with a catchment system 10 and two or more mounts 32 that offset the pipe 12 an optimal amount from the mirrors 30 such that the pipe 12 is at the focal point of the sunlight reflected by the mirror 30.

The cross bars 31 establish the curvature or focal point of the mirrors 30 when used with a semi-flexible backing for the mirror. The mirror surface is preferably a simple reflective coating or foil sprayed or stretched over a frame, respectively. The mirror frame can be a skeleton frame made of steel, aluminum or other material and covered with a light weight plastic or stiff canvas on which the mirror surface can be placed. Light weight mirrors are preferable for easy rotation and positioning throughout the day.

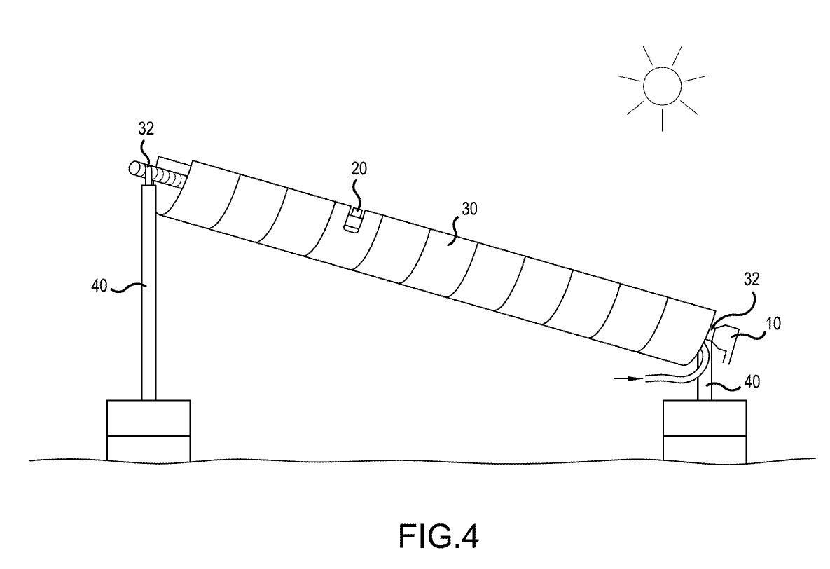

The actuation of the mirrors for tracking of the sun can be performed by a stepper motor which drives a spur gear on a planetary/cylindrical gear provided on the inside of the mounts 32. A control unit can map the progression of the gears to the angle of the mirror and track the sun based on a location based calendar. Other types of tracking systems, such as belt and gear based systems, could be used to maintain maximum exposure to the sun. All angles between 0 degrees and 90 degrees with respect to the ground can be used depending on the terrain, with an exemplary system shown in FIG. 4 for flat terrain. Additionally, the longitudinal extension length of the mirrors are optimally aligned either North (N) or South (S).

The side view of the system in FIG. 4 illustrates how an inclined mirror array would be supported and angled toward the sun. As shown in FIG. 3, the mirror is attached to the pipe 12 and actuated/rotated about the pipe. This view shows that the pipe itself is supported by a similar mount 32 (e.g. blind-hole socket mount) that also encircles the pipe allowing rotation and connected below to a pole 40 and blocks for weighting and stabilization of the relatively light system. This view also shows the configuration F in place in the cylindrical mirror which requires a cut out on both sides in the mirror for the evaporation exit 20 so that the mirror can be rotated beyond 90 degrees in either direction.

The optimization of the system for evaporation or power generation results in other variations. For instance, evaporation preferably has long arrays and thinner pipes to quickly heat water, evaporate a portion and discharge the concentrated salt water all in one pipe. In contrast for power generation at each pipe, shorter thicker pipes that can contain the pressure and temperature necessary to generate dry steam. The cap/valve can act as a piston such that an array of pipes functions much like an engine made up of singly firing tubes which generate power.

The exhaust after the actuating the piston contains water vapor under pressure that is usable by a turbine. In contrast, the evaporated water from the desalinators requires condensation in order to bring the water to liquid form. However, the drop in pressure present in the power generation system at the turbine naturally condenses the water vapor. The evaporation system is cheaper to build with thinner pipes and low pressure valves and pumps which are significantly cheaper.

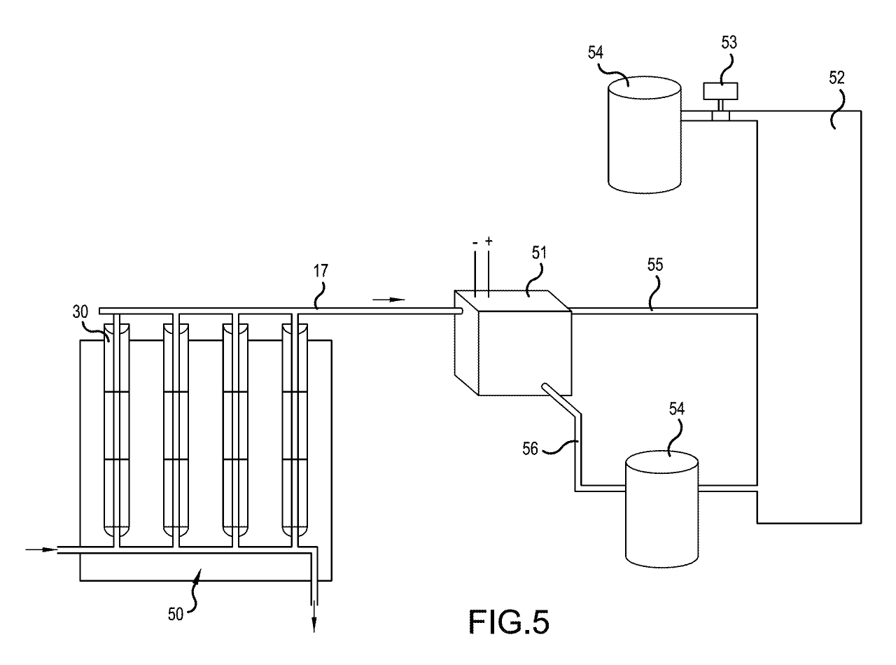

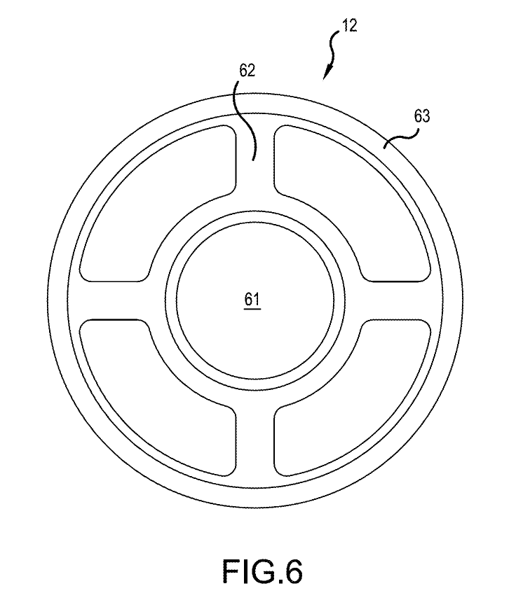

The system diagram of FIG. 5 is a co-generation plant which includes the solar desalination array 50 previously described and generates both power and clean water from sea water. This system operates at high pressures during the middle of the day and at low pressures/temperatures at the tail ends of the day. The system of FIG. 5 is optimized for high pressure power generation. The short desalination array 50 builds up pressure and releases water vapor under pressure via exit pipe 17 into the turbine generator 51 which feeds power into the grid.

From the turbine the condensed air is then passed via exit 55 to a condensation column 52. Here a vacuum pump 53 sucks the water vapor out into a holding container 54 for extra pure water. Alternatively, the condensation column 52 allows the water to condense and fill the column before being pumped out for use. The condensation column can alternatively be a reverse heat exchanger such that incoming ocean water is heated around the outside of the column whilst the air inside the column is cooled by the colder water.

Finally, if only hot sea water can be generated by the desalination columns 50, then the hot sea water can be sprayed into a condensation column 52 and the resulting water vapor is pumped out by the vacuum pump 53. In this case, the exit at the bottom of the condensation column pumps the saltier, unevaporated water out and back to the ocean.

When power is not being generated via the turbine, a switch allows the turbine to be bypassed and the water vapor to pass directly via exit 56 to the storage tank 54 or to the condensation column 52 for additional cooling. The desalination column in the array may simply preheat the water before passing it on to each of the high pressure systems in the desalination array 50. When exit pipe is at low pressure, the turbine is bypassed but when the desalination columns are generating pressure the steam is directed through the turbine.

The concentrated salt water may be passed out of the system back to the ocean by the pipe at the base of the array. Thus, when the pumps are not actively injecting salt water into the pipes 12 of the array, the pipe at the base of the array can allow the pressure in the pipes 12 to force some of their contents out for return to the ocean.

The embodiment including concentric glass tubes is illustrated in FIG. 6 in a cross-section. The central pipe 61 of the heating column 12 is held in place by a web 62 that has a disk shape parallel to the cross-sectional view. Each of the webs 62 are spaced out along the heating column 12. The outer pipe 63 is fixed against the web 62 and is itself fixed to the mounts 32. The ends of the heating pipe 12 can be capped by webs with no gaps to hold heat in. In addition, the central pipe 61 can be fixed to the mount as well. The central pipe 61 is preferably thicker than the outer pipe 63 to retain pressure.

The sea water preferably is pretreated to remove particulates and micro-organisms via a slow sand filter or other passive filter. Even after running all the pumps, sun tracking system and filters, the co-generation plant produces net energy and also desalinates sea water. Naturally, this system requires bright sunshine most of the year and proximity to the ocean. However, current desalination plants are also required to be close to the ocean or an inland sea and can only produce usable water at a significant cost. For instance, the cheapest desalination plants in Israel and Morocco operate via reverse-osmosis and generate water at a cost of about three dollars a gallon.

In this system, usable water is a byproduct of power generation, and therefore, water could be given away by governments while the electricity is sold to support operation of the plant. A simpler system which would only desalinate water and require little maintenance is a variation of the configuration in FIG. 1B where water is heated in a corrosive-proof tube or series of tubes. Then when the sea water is sufficiently hot, it is injected into a condensation column of PPS plastic and the resulting water vapor is pumped off the top while the remaining water and salt is pumped back into the ocean.

Even this method would produce desalinated water at far cheaper rates than conventional systems. All of these systems are designed to be scalable such that the size of the desalination array can dictate the size of the turbine and water storage capacity. Alternatively, even without the turbine the desalination array can generate power via the exit valves 16 in each column such that even single columns for personal or household use could recoup energy to power pumps at least and generate usable water for individual households.

Alternatively, only one large pipe 12 can be used with multiple mirrors directed a the pipe 12 in a configuration much like solar steam electric generation plants. However, in this case the steam is used as condensed after generating energy and converted to potable water. Ideally, the incoming sea water is pre-heated in the condenser as it is used for cooling the condenser.

The invention being thus described, it will be obvious that the same may be varied in many ways including using any of the condensers/coolers utilized in the prior art of the background section as the cooling column. Such variations are not to be regarded as a departure from the spirit and scope of the invention, and all such modifications as would be obvious to one skilled in the art are to be included within the scope of the following claims.

1. A solar desalination system, comprising:
at least one hollow tube with a inlet valve and an exit valve;
at least one cylindrical mirror;
at least four crossbar mounts supporting each cylindrical mirror on each hollow tube; and
an actuator at a top end and a bottom end of the at least one hollow tube, each actuator rotating each hollow tube such that the cylindrical mirror rotates,
wherein the exit valve is connected to a main pipe leading to a power generation plant or condenser,
wherein each hollow tube is centered above each cylindrical mirror, and
wherein the hollow tube is partially filled with salt water.

2. The solar desalination system of claim 1, wherein each top end is elevated above each bottom end such that each hollow tube and cylindrical mirror are slanted.

3. The solar desalination system of claim 1, wherein each inlet valve actively injects semi-purified sea water from a slow sand filter into each hollow tube.

4. The solar desalination system of claim 1, wherein the solar desalination system includes at least four hollow tubes, at least four cylindrical mirrors, one cylindrical mirror for each hollow tube, and at least two actuators for each hollow tube,
wherein each exit valve of the at least four hollow tubes feeds steam generated by solar heat into the main pipe,
wherein the main pipe injects the steam into a electric turbine to generate power,
wherein exhaust from the turbine is fed to a condenser and water condensed by the turbine is fed to a water storage tank, and
wherein the condenser is cooled by sea water coming from an ocean to the inlet valve.

5. The solar desalination system of claim 1, wherein release of steam drives the exit valve as a piston, the exit valve being connected to an electric generator.

6. The solar desalination system of claim 1, wherein injection of water by the inlet valve is synchronized with release of steam by the exit valve.

7. The solar desalination system of claim 6, wherein the inlet valve is a one way valve shut by pressure in the hollow tube.

8. The solar desalination system of claim 1, wherein each hollow tube is surrounded by a concentric glass tube to trap infrared light next to each hollow tube.

9. A solar desalination and power generation plant, comprising:
at least four hollow tubes, each having an inlet valve and an exit valve;
at least four cylindrical mirrors, each hollow tube having a cylindrical mirror;
at least two pivotable mounts for each cylindrical mirror at opposite ends of the mirror; and
at least two actuators at opposite ends of each hollow tube to turn each hollow tube and each cylindrical mirror connected to each hollow tube,
wherein each exit valve of the at least four hollow tubes feeds steam generated by solar heat into a main pipe,
wherein the main pipe injects the steam into a electric turbine to generate power,
wherein exhaust from the electric turbine is fed to a condenser and water condensed by the turbine is fed to a water storage tank, and
wherein each inlet valve actively injects semi-purified sea water from a slow sand filter into each hollow tube.

10. The solar desalination and power generation plant of claim 9, wherein the power from the turbine powers a first pump bringing in sea water, the inlet valves injecting the semi-purified sea water, and a second pump extracting water from the condensing column and the electric turbine.
